(19) United States
(12) Patent Application Publication
(10) Pub. No.: US 2017/0228004 A1
(43) Pub. Date: Aug. 10, 2017

(54) INFORMATION PROCESSING APPARATUS AND METHOD OF CONTROLLING POWER

(71) Applicant: FUJITSU LIMITED, Kawasaki-shi (JP)

(72) Inventor: Masato FUKUMORI, Chofu (JP)

(73) Assignee: FUJITSU LIMITED, Kawasaki-shi (JP)

(21) Appl. No.: 15/388,365

(22) Filed: Dec. 22, 2016

(30) Foreign Application Priority Data
Feb. 4, 2016 (JP) 2016-019664

(51) Int. Cl. G06F 1/26; G06F 1/32

(52) U.S. Cl. CPC G06F 1/266; G06F 1/3296; G06F 1/263

(57) ABSTRACT

An information processing apparatus includes a memory and a processor. The memory is configured to store performance values of respective first computers included in an information processing system. The respective performance values indicate a performance value per unit amount of consumed power. The processor is coupled to the memory. The processor is configured to read the performance values from the memory. The processor is configured to perform, on basis of the performance values, power control of causing second computers among the first computers to perform power limitation of limiting an amount of consumed power in the respective second computers.

### CROSS-REFERENCE TO RELATED APPLICATION

This application is based upon and claims the benefit of priority of the prior Japanese Patent Application No. 2016-019664, filed on Feb. 4, 2016, the entire contents of which are incorporated herein by reference.

### FIELD

The embodiment discussed herein is related to an information processing apparatus and a method of controlling power.

### BACKGROUND

An information processing system including a plurality of computers is known. In the information processing system, the plurality of computers which have received an instruction to execute a job from a user perform computational processes in parallel to realize a fast computational process.

In some cases, the amount of consumed power in each of the computers included in the information processing system may vary depending on the nature of a job to be executed. In some cases, even when the same job is being executed, the amount of consumed power may vary from moment to moment depending on the contents of a process being performed. The total amount of consumed power in the information processing system varies from moment to moment along with the variation of the amount of consumed power in each computer.

A technique to control the amount of consumed power in a computer by changing the operation frequency of a central processing unit (CPU), a supply voltage, the bus bandwidth of peripheral devices, or the like is known. By controlling the amount of consumed power, the computer may be operated in such a manner that the amount of consumed power does not exceed a specified upper limit.

For example, in the information processing system including the plurality of computers, a limit threshold value indicating an upper limit of the amount of consumed power in the entire information processing system and a minimum power guarantee value indicating a lower limit of the amount of consumed power that guarantees the operation of each computer are set. In such a case, a technique is known in which the amount of consumed power in each of computers in which the amount of consumed power exceeds the minimum power guarantee value is limited when the amount of consumed power in the entire information processing system exceeds the limit threshold value.

Related techniques are disclosed in, for example, Japanese Laid-Open Patent Publication No. 2007-213167 and Japanese Laid-Open Patent Publication No. 2014-143907.

However, in the technique to limit the amount of consumed power in each of computers in which the amount of consumed power exceeds the minimum power guarantee value when the amount of consumed power in the entire information processing system exceeds the limit threshold value, the power performance of each computer is not taken into consideration. Here, the “power performance” refers to the performance of computation (the number of times of computation) per unit amount of consumed power.

In some cases, a plurality of computers included in the information processing system may have different configurations of a CPU, a memory, and the like mounted thereon. Even when the information processing system has a plurality of computers of the same configuration, there is a possibility that manufacturing variations occur between the computers.

In the case where the computers have different configurations or manufacturing variations, there is a possibility that the computers may have different power performance levels. When the computers have different power performance levels, even if the amount of consumed power in each of computers in which the amount of consumed power exceeds the minimum power guarantee value is limited, there is a possibility that efficient control of the amount of consumed power in the entire information processing system is not performed.

### SUMMARY

According to an aspect of the present invention, provided is an information processing apparatus including a memory and a processor. The memory is configured to store performance values of respective first computers included in an information processing system. The respective performance values indicate a performance value per unit amount of consumed power. The processor is coupled to the memory. The processor is configured to read the performance values from the memory. The processor is configured to perform, on basis of the performance values, power control of causing second computers among the first computers to perform power limitation of limiting an amount of consumed power in the respective second computers.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of an information processing system according to an embodiment;

FIG. 2 is a diagram illustrating a functional configuration of a power control server according to an embodiment;

FIG. 3 is a diagram illustrating a performance/power ratio table in a power control server according to an embodiment; and

FIG. 4 is a flowchart illustrating a power control process in a power control server according to an embodiment.

### DESCRIPTION OF EMBODIMENT

Hereinafter, an embodiment will be described with reference to the drawings. The following embodiment is just illustrative and is not intended to exclude various modifications and application of techniques which are not explicitly stated in the embodiment. That is, the embodiment may be modified and practiced in different ways without departing from the spirit and scope of the present disclosure.

The figures in the drawings are not intended to include only the illustrated elements but may include other elements or functions.

Throughout the drawings, similar elements or portions are denoted by similar reference numerals or symbols and, therefore, descriptions thereof will not be repeated.

### Embodiment

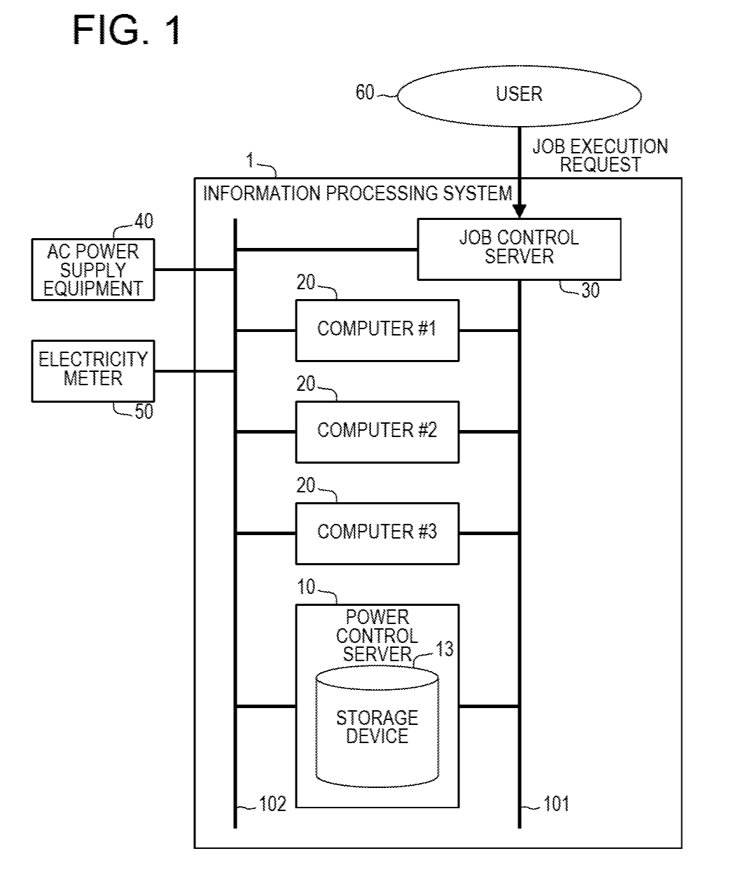

FIG. 1 is a diagram illustrating a configuration of an information processing system 1 according to an embodiment.

As illustrated in FIG. 1, the information processing system 1 includes a power control server 10, a plurality (three in FIG. 1) of computers 20 (computer #1 to #3) and a job control server 30. As illustrated in FIG. 1, the information processing system 1 may be coupled to alternating current (AC) power supply equipment 40 and an electricity meter 50. The “information processing system” may be called a “computer system”.

In the information processing system 1, the power control server 10, the computers 20, and the job control server 30 may be communicably coupled to each other via a communication network 101 (which may also be called a “job control network”).

The AC power supply equipment 40 supplies AC power to the information processing system 1. Specifically, the AC power supply equipment 40 may supply AC power to the power control server 10, the computers 20, and the job control server 30 via an AC power supply network 102. The AC power supply equipment 40 may also supply AC power to the electricity meter 50 via the AC power supply network 102.

The electricity meter 50 measures the amount of consumed power in the information processing system 1. Specifically, the electricity meter 50 may measure the amount of consumed power in the power control server 10, the computers 20, and the job control server 30.

Although it is illustrated in FIG. 1 that the AC power supply equipment 40 and the electricity meter 50 are separated from the information processing system 1, the present disclosure is not limited thereto. For example, the AC power supply equipment 40 and the electricity meter 50 may be provided as the functions of the information processing system 1.

The job control server 30 receives a job execution request from a user 60. The job control server 30 may select one or more computers 20 which execute a job related to the job execution request, from among computers 20 which do not execute other jobs, and may instruct the selected one or more computers 20 to execute the job. In other words, the job control server 30 may distribute the job related to the job execution request to the one or more computers 20.

When the information processing system 1 includes the plurality of computers 20 as illustrated in FIG. 1, the plurality of computers 20 which have received an instruction to execute a job may perform parallel computational processes to realize a fast computational process.

Each computer 20 may execute a job. Specifically, the computers 20 may execute a job distributed by the job control server 30. The computers 20 may execute different jobs or may execute a common job in parallel.

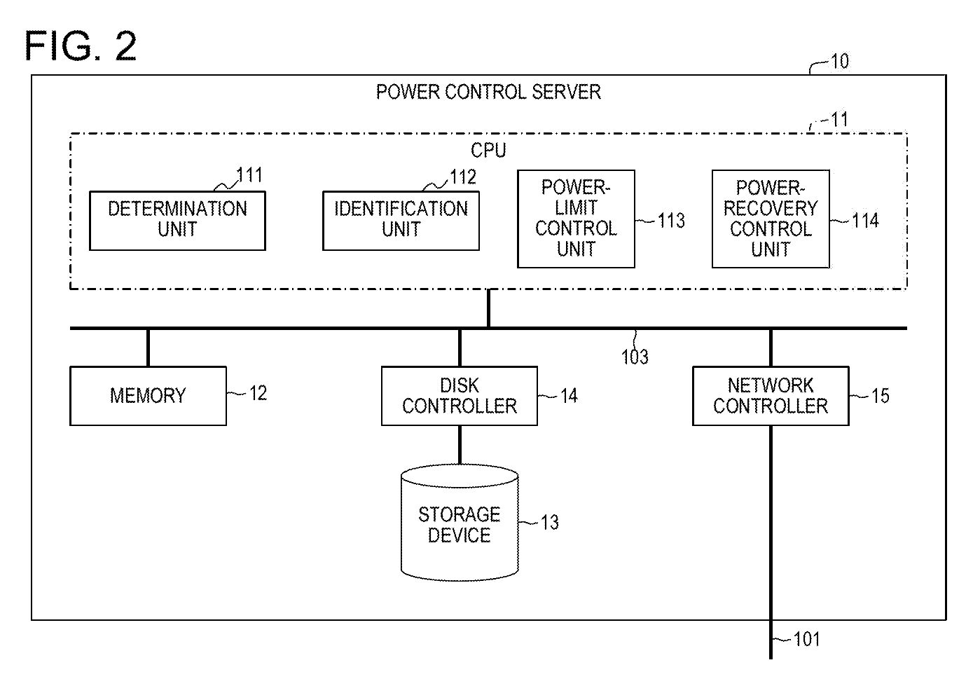

Each computer 20 may be a hardware unit which includes a CPU, a memory, and peripheral devices and may perform independent computation. Specifically, as in the power control server 10 to be described later with reference to FIG. 2, the computer 20 may include a CPU 11, a memory 12, a storage device 13, a disk controller 14, and a network controller 15. However, unlike the power control server 10 to be described later with reference to FIG. 2, the CPU 11 in the computer 20 does not include functions as a determination unit 111, an identification unit 112, a power-limit control unit 113, and a power-recovery control unit 114.

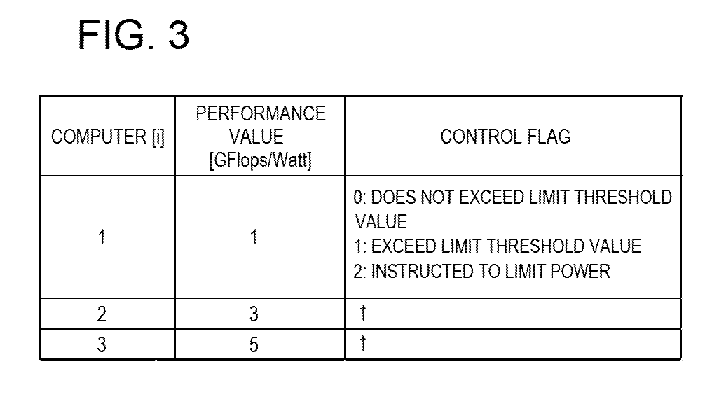

The power control server 10 is an example of an information processing apparatus and controls the amount of consumed power in each computer 20. In order to control the amount of consumed power in the computers #1 to #3, the power control server 10 may store performance/power ratio information of the computers #1 to #3 in the storage device 13 (described later with reference to FIG. 2). The performance/power ratio information will be described in detail later with reference to FIG. 3.

FIG. 2 is a diagram illustrating a functional configuration of the power control server 10 according to the embodiment.

As illustrated in FIG. 2, the power control server 10 includes the CPU 11, the memory 12, the storage device 13, the disk controller 14, and the network controller 15. The CPU 11, the memory 12, the disk controller 14, and the network controller 15 may be communicably coupled to each other via a system bus 103.

The network controller 15 communicably couples its own device (power control server 10) to other devices (computers 20 and job control server 30) via the communication network 101.

The disk controller 14 is an interface for communicably coupling the CPU 11 to the storage device 13, such as a fibre channel (FC) adapter. The CPU 11 may write/read data to/from the storage device 13 through the disk controller 14.

The storage device 13 is a device which stores therein data in a readable and writable manner, such as a hard disk drive (HDD) or a solid state drive (SSD). The “storage device” may be called a “physical disk” or an “auxiliary storage device”. The storage device 13 may function as a storage unit.

The storage device 13 may store therein the performance/power ratio information (described later with reference to FIG. 3) including information on a performance value per unit amount of consumed power in each computer 20. The power control server 10 may acquire the performance/power ratio information from each computer 20 via the communication network 101.

The memory 12 is a storage device including a read-only memory (ROM) and a random access memory (RAM). A program such as a basic input/output system (BIOS) may be written in the ROM of the memory 12. A software program of the memory 12 may be appropriately read into and executed by the CPU 11. The RAM of the memory 12 may be used as a primary memory or a working memory. The “memory” may be called a “main memory”.

The CPU 11 is a processor which performs a variety of controls and computations, and implements a variety of functions by executing an operating system (OS) and programs stored in the memory 12. As illustrated in FIG. 2, the CPU 11 may function as the determination unit 111, the identification unit 112, the power-limit control unit 113 and the power-recovery control unit 114.

A program (which may also be called a “power control program”) for implementing the functions of these determination unit 111, identification unit 112, power-limit control unit 113, and power-recovery control unit 114 may be provided in a form recorded in a computer-readable recording medium such as a flexible disk, compact disc (CD) such as CD-ROM, CD-R, CD-RW, and the like, digital versatile disc (DVD) such as DVD-ROM, DVD-RAM, DVD-R, DVD+R, DVD-RW, DVD+RW, HD DVD, and the like, Blu-ray disk, magnetic disk, optical disk, magneto-optic disk, or the like. A computer (CPU 11) may read the program from the above-mentioned recording medium through a reader (not illustrated) and transmit/store the read program to/in an internal recording device or an external recording device for use later. The program may be recorded in a storage device (recording medium) such as a magnetic disk, optical disk, magneto-optic disk, or the like and may be provided from the storage device to a computer via a communication path.

In implementing the functions of the determination unit 111, the identification unit 112, the power-limit control unit 113, and the power-recovery control unit 114, the program stored in the internal storage device (memory 12) may be executed by the computer (CPU 11). The program recorded in the recording medium may be read and executed by the computer.

A device for controlling the overall operation of the power control server 10 is not limited to the CPU 11 but may be, for example, one of micro processing unit (MPU), digital signal processor (DSP), application specific integrated circuit (ASIC), programmable logic device (PLD), and field programmable gate array (FPGA). The device for controlling the overall operation of the power control server 10 may be a combination of two or more of the CPU, MPU, DSP, ASIC, PLD, and FPGA.

The determination unit 111 makes a determination based on the total amount of consumed power in the information processing system 1. The determination unit 111 may function as a first determination unit which determines whether or not the total amount of consumed power in the information processing system 1 is equal to or larger than a limit threshold value (“first threshold value”). In addition, the determination unit 111 may function as a second determination unit which determines whether or not the total amount of consumed power in the information processing system 1 is equal to or smaller than a recovery threshold value (“third threshold value”).

Information on the limit threshold value and the recovery threshold value may be stored in a predetermined area of the memory 12 or the storage device 13. The recovery threshold value may be smaller than the limit threshold value.

The determination unit 111 may acquire the amount of consumed power in each of the computers 20 and the job control server 30, which is reported by each of the computers 20 and the job control server 30 at a similar timing. Then, the determination unit 111 may make a determination based on the total amount of consumed power in the information processing system 1 by calculating the sum of the acquired amounts of consumed power and the amount of consumed power in the power control server 10.

The determination unit 111 may acquire the amount of consumed power in each of the computers 20 and the job control server 30 by inquiring each of the computers 20 and the job control server 30 at a similar timing. Then, the determination unit 111 may make a determination based on the total amount of consumed power in the information processing system 1 by calculating the sum of the acquired amounts of consumed power and the amount of consumed power in the power control server 10.

Further, the determination unit 111 may acquire the amount of consumed power in the power control server 10, each computer 20, and the job control server 30 from the electricity meter 50, and may make a determination based on the total amount of consumed power in the information processing system 1 by calculating the sum of the acquired amounts of consumed power.

The identification unit 112 identifies a computer in which the amount of consumed power is equal to or larger than an individual threshold value (“second threshold value”) among the plurality of computers 20.

Information on the individual threshold value may be stored in a predetermined area of the memory 12 or the storage device 13. The individual threshold value may be smaller than the limit threshold value and the recovery threshold value.

The identification unit 112 may identify a computer 20 in which the amount of consumed power is equal to or larger than the individual threshold value, based on the amount of consumed power in each computer 20, which is acquired by the determination unit 111.

The identification unit 112 may set a control flag (described later with reference to FIG. 3) related to the identified computer 20 in the performance/power ratio information to “1”.

The power-limit control unit 113 may cause a computer 20 to limit the amount of consumed power. Specifically, the power-limit control unit 113 may cause at least one of the plurality of computers 20 to limit the amount of consumed power, based on the performance/power ratio information stored in the storage device 13.

When operating the computer 20 with reduced amount of consumed power, the computational performance of the computer 20 is lowered. That is, the power-limit control unit 113 lowers the computational performance of the computer 20.

When it is determined by the determination unit 111 that the total amount of consumed power in the information processing system 1 is equal to or larger than the limit threshold value, the power-limit control unit 113 may cause at least one computer 20 to limit the amount of consumed power.

The power-limit control unit 113 may cause a computer 20 identified by the identification unit 112 to limit the amount of consumed power. The power-limit control unit 113 may cause a computer 20 to limit the amount of consumed power by setting the amount of consumed power in the computer 20 to be smaller than the individual threshold value.

FIG. 3 is a diagram illustrating a performance/power ratio table in the power control server 10 according to the embodiment.

The performance/power ratio table is obtained by expressing the performance/power ratio information stored in the storage device 13 in a table format.

The performance/power ratio table may include columns of “computer [i]”, “performance value [GFlops/Watt]” and “control flag”. In other words, the performance/power ratio information may be information in which an identification number of a computer 20, a performance value of the computer 20, and a control flag allocated to the computer 20 are associated with each other.

The “computer [i]” indicates an identification number of the computer 20. In the example illustrated in FIG. 3, the numbers “1” to “3” respectively indicating identification numbers of the computers #1 to #3 illustrated in FIG. 1 are registered in the column of “computer [i]”.

The “performance value [GFlops/Watt]” indicates a performance value per unit amount of consumed power (which may be called a “computational performance value” or a “power performance value”) in each computer 20. The unit [GFlops/Watt] indicates the number of times of a floating point arithmetic operation which may be executed for one second using one watt of power. In the example illustrated in FIG. 3, the numbers “1”, “3” and “5” are respectively registered as performance values of the computers #1 to #3 in the column of “performance value [GFlops/Watt]”.

The performance value may be measured in advance by a test at the manufacture of each computer 20 or at the construction of the information processing system 1.

The performance value is not limited to the number of times of a floating point arithmetic operation which may be executed for one second using one watt of power. The performance value may be another benchmark value such as the million instructions per second (MIPS) or a benchmark value set by standard performance evaluation corporation (SPEC).

The “control flag” indicates the state of power control of each computer 20. In a column of “control flag”, the number “0” may indicate that the amount of consumed power in the computer 20 does not exceed the limit threshold value, the number “1” may indicate that the amount of consumed power in the computer 20 exceeds the limit threshold value, and the number “2” may indicate that the computer 20 is instructed to limit the power. In the column of “control flag”, the number “0” may be set in advance as an initial value for each computer 20.

The power-limit control unit 113 may cause a computer 20 having the smallest performance value, among the plurality of computers 20, to limit the amount of consumed power. In the example illustrated in FIG. 3, the power-limit control unit 113 may cause the computer #1 having the smallest performance value of “1” [GFlops/Watt] to limit the amount of consumed power.

The power-limit control unit 113 may sequentially select the computers 20 in ascending order of the performance value from among the computers 20 that are not yet caused to limit the amount of consumed power value, until the total amount of consumed power in the information processing system 1 becomes smaller than the limit threshold value, and cause the selected computers 20 to limit the amount of consumed power. In other words, the power-limit control unit 113 may sequentially select the computers 20 with the control flag set to “1”, in ascending order of the performance value, until the total amount of consumed power in the information processing system 1 becomes smaller than the limit threshold value, and cause the selected computers 20 to limit the amount of consumed power.

In the example illustrated in FIG. 3, the power-limit control unit 113 selects the computer #1 having the smallest performance value and causes the selected computer #1 to limit the amount of consumed power. However, when the total amount of consumed power in the information processing system 1 remains equal to or larger than the limit threshold value, the power-limit control unit 113 may select a computer 20 other than the computer #1. For example, the power-limit control unit 113 may select the computer #2 having the second smallest performance value of “3” [GFlops/Watt] and cause the selected computer #2 to limit the amount of consumed power.

In addition, the power-limit control unit 113 may set, in the performance/power ratio information, the control flag related to a computer 20, which is caused to limit the amount of consumed power, to “2”.

The power-recovery control unit 114 causes a computer 20 to release the limitation of the amount of consumed power. Specifically, when it is determined by the determination unit 111 that the total amount of consumed power in the information processing system 1 is equal to or smaller than the recovery threshold value, the power-recovery control unit 114 may cause the computer 20, which has been caused to limit the amount of consumed power by the power-limit control unit 113, to release the limitation of the amount of consumed power.

In addition, the power-recovery control unit 114 may set, in the performance/power ratio information, the control flag related to the computer 20 which is caused to release the limitation of the amount of consumed power, to “0”.

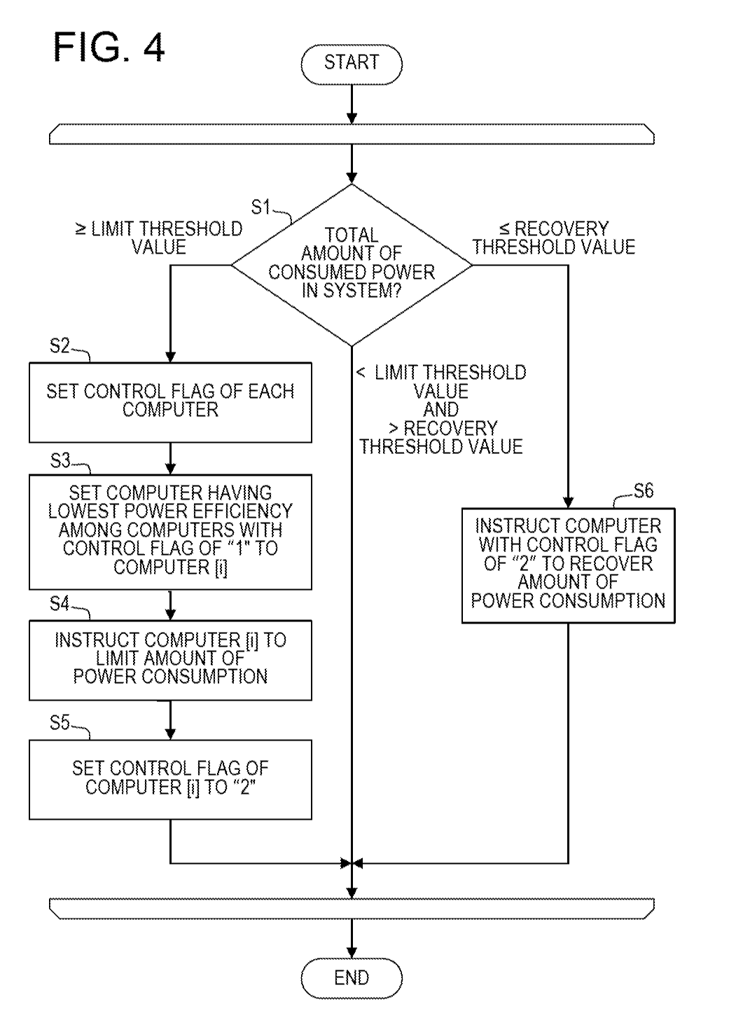

A power control process in the power control server 10 according to the embodiment will be described below with reference to the flowchart illustrated in FIGS. 4. S1 to S6 may be repeated during the power control server 10 is in operation.

The determination unit 111 makes a determination on the total amount of consumed power in the information processing system 1 (S1).

When it is determined that the total amount of consumed power in the information processing system 1 is equal to or larger than the limit threshold value (“≧limit threshold value” in S1), the identification unit 112 sets the control flag of each computer 20 on the basis of the individual threshold value (S2). Specifically, the identification unit 112 may set the control flag of a computer 20 in which the amount of consumed power exceeds the individual threshold value, to “1”. In addition, the identification unit 112 may set the control flag of a computer 20 in which the amount of consumed power does not exceed the individual threshold value, to “0”.

The power-limit control unit 113 sets a computer 20 having the smallest performance value (“power efficiency”) among the computers 20 with the control flag of “1” to computer [i] by referring to the performance/power ratio information (S3).

The power-limit control unit 113 issues a power limit instruction to the computer [i] (S4). In other words, the power-limit control unit 113 causes the computer [i] to limit the amount of consumed power. The computer [i] may limit the amount of consumed power in its own devices in accordance with the power limit instruction from the power control server 10.

The power-limit control unit 113 sets the control flag of the computer [i] to “2” (S5). Then, the process returns to S1.

At S1, when it is determined that the total amount of consumed power in the information processing system 1 is smaller than the limit threshold value and larger than the recovery threshold value (“<limit threshold value and >recovery threshold value” in S1), the power control server 10 performs no particular operation. Then, the operation of S1 is repeated.

At S1, when it is determined that the total amount of consumed power in the information processing system 1 is equal to or smaller than the recovery threshold value (“≦recovery threshold value” in S1), the power-recovery control unit 114 issues a power recovery instruction to the computer 20 with the control flag of “2” (S6). In other words, the power-recovery control unit 114 causes the computer 20 to release the limitation of the amount of consumed power. The computer [i] may release the limitation of the amount of consumed power in its own devices in accordance with the power recovery instruction from the power control server 10. In addition, the power-recovery control unit 114 sets the control flags of all the computers 20 to “0”. Then, the process returns to S1.

The power control server 10 according to the embodiment may provide, for example, the following effects.

The power-limit control unit 113 causes at least one of the plurality of computers 20 to limit the amount of consumed power on the basis of the performance value stored in the storage device 13.

Accordingly, the amount of consumed power may be controlled with high efficiency. Specifically, in consideration of a variation of the performance value of each computer 20, the total amount of consumed power in the information processing system 1 may be limited while suppressing a deterioration of the computational performance of the information processing system 1 as much as possible.

When it is determined by the determination unit 111 that the total amount of consumed power in the information processing system 1 is equal to or larger than the limit threshold value, the power-limit control unit 113 causes at least one computer 20 to limit the amount of consumed power.

Accordingly, when the total amount of consumed power in the information processing system 1 is increased, the amount of consumed power may be limited. By limiting the total amount of consumed power in the information processing system 1 to be smaller than the limit threshold value, the operation costs of the information processing system 1 may be saved.

The identification unit 112 identifies a computer 20 in which the amount of consumed power is equal to or larger than the individual threshold value, among the plurality of computers 20. Then, the power-limit control unit 113 causes the computer 20 identified by the identification unit 112 to limit the amount of consumed power.

Accordingly, the amount of consumed power in a computer 20 in which a large amount of power is consumed may be reduced.

The power-limit control unit 113 causes a computer 20 to limit the amount of consumed power by setting the amount of consumed power to be smaller than the individual threshold value.

Accordingly, the amounts of consumed power in the plurality of computers 20 may be equalized and hence the load may be distributed between the plurality of computers 20.

The power-limit control unit 113 causes a computer 20 with the smallest performance value to limit the amount of consumed power.

Accordingly, the total amount of consumed power in the information processing system 1 may be reduced while suppressing a deterioration of the performance of a computer having a larger (better) performance value as much as possible.

The power-limit control unit 113 sequentially selects computers 20 which are not yet caused to limit the amount of consumed power, in ascending order of the amount of consumed power, until the total amount of consumed power in the information processing system 1 becomes smaller than the limit threshold value, and causes the selected computers 20 to limit the amount of consumed power.

Accordingly, by limiting the total amount of consumed power in the information processing system 1 to be smaller than the limit threshold value, the operation costs of the information processing system 1 may be reliably saved.

When it is determined by the determination unit 111 that the total amount of consumed power in the information processing system 1 is equal to or smaller than the recovery threshold value, the power-recovery control unit 114 causes the computer 20, which has been caused to limit the amount of consumed power by the power-limit control unit 113, to release the limitation of the amount of consumed power.

Accordingly, when the total amount of consumed power in the information processing system 1 is decreased, the limitation of the amount of consumed power in the computer 20 may be released and hence the information processing system 1 may be operated with high efficiency.

The recovery threshold value is smaller than the limit threshold value.

Accordingly, when the total amount of consumed power in the information processing system 1 is slightly smaller than the limit threshold value, the amount of consumed power in the computer 20 may be prevented from being recovered and the total amount of consumed power in the information processing system 1 may be prevented from being oscillated around the limit threshold value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
a memory configured to
store performance values of respective first computers included in an information processing system, the respective performance values indicating a performance value per unit amount of consumed power; and
a processor coupled to the memory and the processor configured to read the performance values from the memory, and
perform, on basis of the performance values, power control of causing second computers among the first computers to perform power limitation of limiting an amount of consumed power in the respective second computers.

2. The information processing apparatus according to claim 1, wherein the processor is configured to
determine whether a first amount is equal to or larger than a first threshold value, the first amount being a total amount of consumed power in the information processing system, and
perform the power control upon determining that the first amount is equal to or larger than the first threshold value.

3. The information processing apparatus according to claim 2, wherein the processor is configured to
select the second computers from third computers in which the amount of consumed power is equal to or larger than a second threshold value, the second threshold value being smaller than the first threshold value.

4. The information processing apparatus according to claim 3, wherein the processor is configured to
perform the power control by causing the second computers to perform the power limitation by reducing the amount of consumed power to an amount smaller than the second threshold value.

5. The information processing apparatus according to claim 3, wherein the processor is configured to
select the second computers to include a computer having a smallest performance value among the third computers.

6. The information processing apparatus according to claim 3, wherein the processor is configured to
select the second computers from the third computers in ascending order of the performance value until the first amount becomes smaller than the first threshold value.

7. The information processing apparatus according to claim 3, wherein the processor is configured to
determine whether the first amount is equal to or smaller than a third threshold value, the third threshold value being smaller than the first threshold value, and
cause, upon determining that the first amount is equal to or smaller than the third threshold value, the second computers to release the power limitation.

8. A non-transitory computer-readable recording medium having stored therein a program that causes a processor to execute a process, the process comprising:
reading, from a memory, performance values of respective first computers included in an information processing system, the respective performance values indicating a performance value per unit amount of consumed power; and
performing, on basis of the performance values, power control of causing second computers among the first computers to perform power limitation of limiting an amount of consumed power in the respective second computers.

9. The non-transitory computer-readable recording medium according to claim 8, the process further comprising:
determining whether a first amount is equal to or larger than a first threshold value, the first amount being a total amount of consumed power in the information processing system; and
performing the power control upon determining that the first amount is equal to or larger than the first threshold value.

10. The non-transitory computer-readable recording medium according to claim 9, the process further comprising:
selecting the second computers from third computers in which the amount of consumed power is equal to or larger than a second threshold value, the second threshold value being smaller than the first threshold value.

11. The non-transitory computer-readable recording medium according to claim 10, the process further comprising:
performing the power control by causing the second computers to perform the power limitation by reducing the amount of consumed power to an amount smaller than the second threshold value.

12. The non-transitory computer-readable recording medium according to claim 10, the process further comprising:
selecting the second computers to include a computer having a smallest performance value among the third computers.

13. The non-transitory computer-readable recording medium according to claim 10, the process further comprising:
selecting the second computers from the third computers in ascending order of the performance value until the first amount becomes smaller than the first threshold value.

14. The non-transitory computer-readable recording medium according to claim 10, the process further comprising:
determining whether the first amount is equal to or smaller than a third threshold value, the third threshold value being smaller than the first threshold value; and
causing, upon determining that the first amount is equal to or smaller than the third threshold value, the second computers to release the power limitation.

15. A method of controlling power, the method comprising:
reading by a processor, from a memory, performance values of respective first computers included in an information processing system, the respective performance values indicating a performance value per unit amount of consumed power; and
performing, on basis of the performance values, power control of causing second computers among the first computers to perform power limitation of limiting an amount of consumed power in the respective second computers.

16. The method according to claim 15, further comprising:
determining whether a first amount is equal to or larger than a first threshold value, the first amount being a total amount of consumed power in the information processing system; and
performing the power control upon determining that the first amount is equal to or larger than the first threshold value.

17. The method according to claim 16, further comprising:
selecting the second computers from third computers in which the amount of consumed power is equal to or larger than a second threshold value, the second threshold value being smaller than the first threshold value.

18. The method according to claim 17, further comprising:
performing the power control by causing the second computers to perform the power limitation by reducing the amount of consumed power to an amount smaller than the second threshold value.

19. The method according to claim 17, further comprising:
selecting the second computers to include a computer having a smallest performance value among the third computers.

20. The method according to claim 17, further comprising:
selecting the second computers from the third computers in ascending order of the performance value until the first amount becomes smaller than the first threshold value.
